(19) United States
(12) Patent Application Publication
(10) Pub. No.: US 2005/0108135 A1
(43) Pub. Date: May 19, 2005

(54) Methods and apparatus for allowing consumers to make choices among financial service providers and providing incentives to the consumers

(75) Inventors: Timothy Daniel Foley, Raleigh, NC (US); Paul S. Krupa, Raleigh, NC (US); Dale Frederick Adams, Raleigh, NC (US); Arthur O'Connor, Wake Forest, NC (US)

Correspondence Address: PRIEST & GOLDSTEIN PLLC, 5015 SOUTHPARK DRIVE, SUITE 230, DURHAM, NC, 27713-7736, US

(73) Assignee: GE Mortgage Holdings, LLC, Raleigh, NC (US)

(21) Appl. No.: 10/714,272

(22) Filed: Nov. 14, 2003

(51) Int. Cl. G06F 17/60

(52) U.S. Cl. 705/36

(57) ABSTRACT

Systems and techniques for promotion of financial services to consumers are described. In one aspect, a system comprises a database of provider information including identification of affiliated providers, the services offered by the providers and categories of customers served by the providers and incentives offered by the providers, as well as an incentive information database including identification of incentives offered in exchange for selecting affiliated providers, levels of incentives offered and qualification requirements for each incentive and incentive level. The system further includes a user registration module allowing registration of a consumer in order to allow selection of providers, the user registration module storing user information and preferences for delivery to affiliated providers for use in conducting transactions and a selection module for coordinating selection by a consumer of affiliated providers and managing qualification for and delivery of incentives offered for selecting affiliated providers.

### FIELD OF THE INVENTION

The present invention relates generally to advantageous systems and techniques for marketing of financial service products. More particularly, the invention relates to techniques for electronic and Internet based systems and techniques for providing information to consumers about available mortgage insurance and home loan products, allowing selection of such products and providing incentives to consumers who select products affiliated with the entity providing the information and allowing the selection.

### BACKGROUND OF THE INVENTION

Purchase or financing of a home by a consumer is a substantial transaction. A service provider that is selected by a consumer to assist with the home financing can expect to receive substantial revenues, as well as an opportunity to build and maintain an ongoing relationship with the consumer. As consumers become more and more sophisticated and have greater and greater access to information, competition among financial service providers becomes more intense.

Two significant financial service products that are associated with many home financing transactions are mortgage financing and private mortgage insurance. Both products typically involve a long term relationship with the consumer and a stream of monthly payments lasting for years. Traditionally, a consumer seeking a mortgage loan selects a mortgage provider and the mortgage provider selects and contracts with a private mortgage insurance provider. The consumer has no hand in selecting the private mortgage insurance provider. A mortgage provider that was able to market its services directly to consumers would gain a substantial competitive advantage.

Because of the typically substantial size of the transactions involved, it is worthwhile for both the mortgage provider and the mortgage insurer to provide incentives to the consumer in exchange for being selected to assist with the transaction. Consumers like to receive incentives, and they develop a strongly favorable impression toward service providers who provide them with good services at a fair price and who also show their appreciation by giving them special incentives in exchange for receiving their business.

There exists, therefore, a need for systems and techniques for allowing providers of financial services such as mortgage insurance to market their services directly to a consumer, to allow the consumer to select affiliated service providers who will handle various aspects of the transaction and which provide the ability to offer incentives to the consumer in exchange for selecting particular providers.

### SUMMARY OF THE INVENTION

In order to address such needs, one aspect of the present invention provides a system for coordinating consumer selection of financial services. The system comprises a database of provider information including identification of affiliated providers, the services offered by the providers and categories of customers served by the providers and incentives offered by the providers, as well as an incentive information database including identification of incentives offered in exchange for selecting affiliated providers, levels of incentives offered and qualification requirements for each incentive and incentive level. The system may further include a user registration module allowing registration of a consumer in order to allow selection of providers, the user registration module storing user information and preferences for delivery to affiliated providers for use in conducting transactions and a selection module for coordinating selection by a consumer of affiliated providers and managing qualification for and delivery of incentives offered for selecting affiliated providers.

In another aspect of the invention, a process is provided for promotion of financial services to consumers. The process may suitably comprise the steps of collecting and storing registration information from a user in order to collect identifying information from the user and to identify likely user needs and preferences. The process may further comprise the step of identifying potential service providers for financial services likely to be required by the user and presenting information and tools for allowing user selection of a desired provider, as well as information about incentives offered for selecting from a set of designated providers. Upon user selection of a desired provider and entry into a transaction with the provider, qualification information indicating the user's eligibility for an incentive is received. The qualification information is validated and the user is allowed to select and claim the desired incentive.

A more complete understanding of the invention, as well as further features and advantages of the invention, will be apparent from the following Detailed Description and from the claims which follow below.

### BRIEF DESCRIPTION OF THE DRAWINGS

FIG. 1 illustrates a financial services information and selection system according to an aspect of the present invention;

FIG. 2 illustrates a hypertext page presented as a user interface to a system according to an aspect of the present invention;

FIG. 3 illustrates an initial registration page according to an aspect of the present invention;

FIG. 4 illustrates a hypertext page used as an introduction to selecting a mortgage financing provider using a system according to an aspect of the present invention;

FIG. 5 illustrates a hypertext page used in selecting an incentive using a system according to an aspect of the present invention;

FIG. 6 illustrates a page used as an interface in making a selection of a mortgage financing provider according to an aspect of the present invention;

FIG. 7 illustrates a user information page presented by a system according to an aspect of the present invention;

FIG. 8 illustrates a hypertext page providing instructions and an interface for a user to claim an incentive using a system according to an aspect of the present invention;

FIGS. 9-12 illustrate pages providing educational information using a system according to an aspect of the present invention; and

FIG. 13 illustrates a process of managing selection of financial services according to an aspect of the present invention.

### DETAILED DESCRIPTION

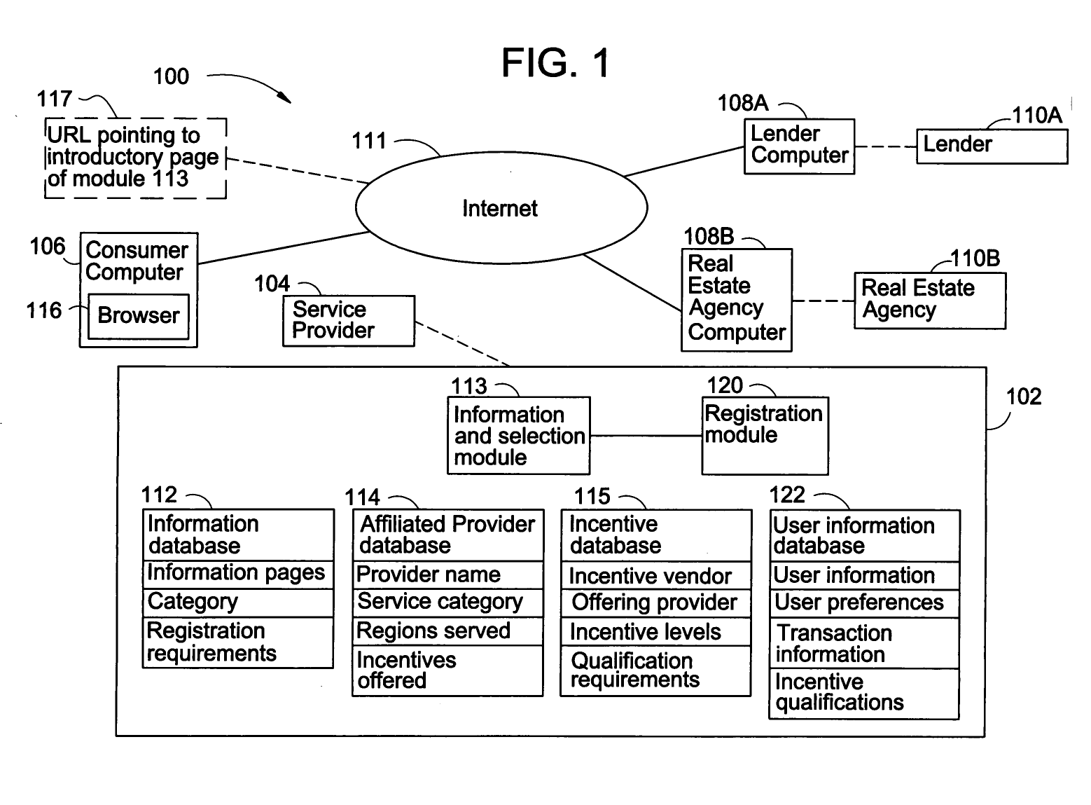

FIG. 1 illustrates a financial services information and selection system 100 according to an aspect of the present invention. The system 100 includes a server 102 operated by a service provider 104. In the present example, the service provider 104 may suitably be a mortgage insurance company. The server 102 communicates with a plurality of consumer operated computers, for example, computer 106, and may also communicate with various computers operated by or for affiliated companies, for example, computers 108A and 108B maintained by or providing services to a lender 110A and a real estate agency 110B. Communication between the server 102, the remote consumer computer 106 and the affiliated company computers 108A and 108B is preferably accomplished through a publicly accessible network 111, such as the Internet. The service provider 104 typically has contracts with each of a plurality of service providers such as lenders, real estate agents, builders and the like. Many more consumers, consumer computers, affiliated companies and affiliated company computers can be included in the system 100, but for simplicity of illustration, only one consumer computer 106, two affiliated companies 110A and 110B and two affiliated company computers 108A and 108B are shown here.

The server 102 maintains an information database 112 of educational and promotional information relating to topics of likely interest to consumers likely to be interested in the services offered by the service provider 104, such as a description of the function and benefits of mortgage insurance. The database 112 also includes promotional information for informing consumers about the specific services provided by the service provider 104. The server 102 may also host a financial services information and selection module 113 that can be used by consumers to obtain educational and promotional information and to select financial services offered through the system 100. The server 102 also maintains an incentive database 114 storing information about incentives, such as offers and discounts, provided by various vendors under contract with the service provider 104, and which may be made available to consumers selecting financial services offered through the system 100.

A user of a consumer operated computer such as the computer 106, suitably establishes a connection with the server 102 through a browser 116 operating on the computer 106. The browser 116 is typically directed to the financial services information and selection module 113 through the entry of a uniform resource locator (URL) 117 or through activation of a hyperlink pointing to the financial services information and selection module 113. Such hyperlinks may suitably appear in other pages maintained by or for the provider 104 or in online advertising sponsored by the provider 104. The financial services information and selection module 113 suitably provides an interface implemented in the form of a collection of web pages hosted on the server 102.

The introductory web page of the module 113 allows the user to browse through promotional and educational information and to activate various links to obtain additional information. The module 113 may advantageously be designed and programmed so that the user is able to gain access to some of the information on the server 102 without registering or identifying himself or herself. The server 102 may, however, offer additional information that is accessible to the user only upon registration. In addition to allowing access to additional information, registration may allow the user to gain access to services. The willingness of a user to provide verifiable personal information to a financial service provider 104 helps to identify the user as a customer genuinely in need of the offered services, making it more worthwhile to the service provider 104 to provide additional information and services. In addition, information supplied at registration may more specifically identify the services of interest to the user so that promotional information supplied to the user may be more directly focused on the user's needs.

The server 102 therefore hosts a user registration module 120 and a user information database 122. The pages presented by the module 113 preferably include links for invoking the user registration module 120 and the user invokes the registration module 120 by activating such a link. In order to make it easy for users to register at any time, each hypertext page used by the module 113 may suitably include a link to the registration module 120. When invoked, the registration module 120 presents a registration form to the user, allowing the user to select a username and password and enter identifying information. Once the user has registered, the identifying information is stored in the user information database 122 and additional links and databases are made available to the user. Once a user has registered, he or she may log in at a later time and have his or her stored information available at that time.

After the user has accomplished registration, he or she may employ the module 113 to choose from among various service providers affiliated with the service provider 104. While a lender 110A and a real estate agency 10B are shown here for simplicity of illustration, it will be recognized that a system such as the system 100 may be designed or programmed so that numerous different providers and categories of providers may be available for selection.

Presentation of the various categories of providers may be tailored to user preferences expressed at the time of registration or otherwise. For example, the user may be interested in searching for a home for purchase, may intend to build a new home, may be searching for mortgage refinancing or may be seeking to sell his or her present home and purchase a new home. In each case, the user is likely to desire mortgage financing, but in the first case the user may also require a real estate agent, in the second case the user may require a real estate agent, a builder, or both and in the final case the user may wish to select real estate agents for the sale of the existing home and the purchase of the new home. In each case, the module 113 would examine the user information database 122 and present information about those providers most likely to be needed.

Once a user has registered or logged in, the financial services selection module 113 examines the login information and retrieves user information associated with the login information. The financial services selection module examines the user information to determine which services are likely to be needed by the user. The module 113 then presents a selection page. Services that have been determined as likely to be of interest are prominently displayed, and links or paths for the selection of other services are provided. For example, a link to a secondary page may be shown, with the secondary page displaying services that have been determined to be less likely to be needed. The user selects desired services and upon selection, the user information database 122 is updated with the selections.

In addition to providing the ability to select financial services, the system 100 also allows the offering of incentives associated with one or more financial services to be selected by the user. Preferably, a variety of incentives are associated with each financial service, so that a user selecting a particular financial service may have a variety of incentives to choose from. Exemplary incentives may include, for example, a 10% discount coupon for a single purchase at a home repair or home entertainment store, an special rate on monthly landscaping services, special rate financing on a second mortgage or a home equity line of credit, or the like. Upon selection of an incentive by the user, the server 102 logs the selection in the user information database 122 and presents instructions for obtaining the incentive. Suitably, qualification for the incentive may be made contingent on consummating a transaction. For example, the user may be required to close a mortgage with a chosen provider, with the mortgage having mortgage insurance underwritten by the service provider 104, in order to obtain the incentive. Thus, the instructions may specify that the user must provide a transaction number or other information providing evidence that a transaction has been consummated, in order to receive the incentive. The instructions may be printed by the user under the control of the consumer operated computer 106A. In addition, the user may retrieve the instructions when desired by logging in using the user registration module 120, which can then retrieve the user selections and prepare a replacement set of instructions. Also, if desired, the user may be allowed to change his or her incentive selection at any time before consummation of the transaction associated with the incentive, or at any time before actually claiming the incentive. The user may be allowed to log in and review his or her past selections. The selection information is suitably presented in the form of a hypertext page, with the hypertext page including links that, when activated, invoke information and selection module 113 to allow changes to the original incentive selection. Instructions for obtaining the incentive are provided and the user information database 122 is updated with the revised information.

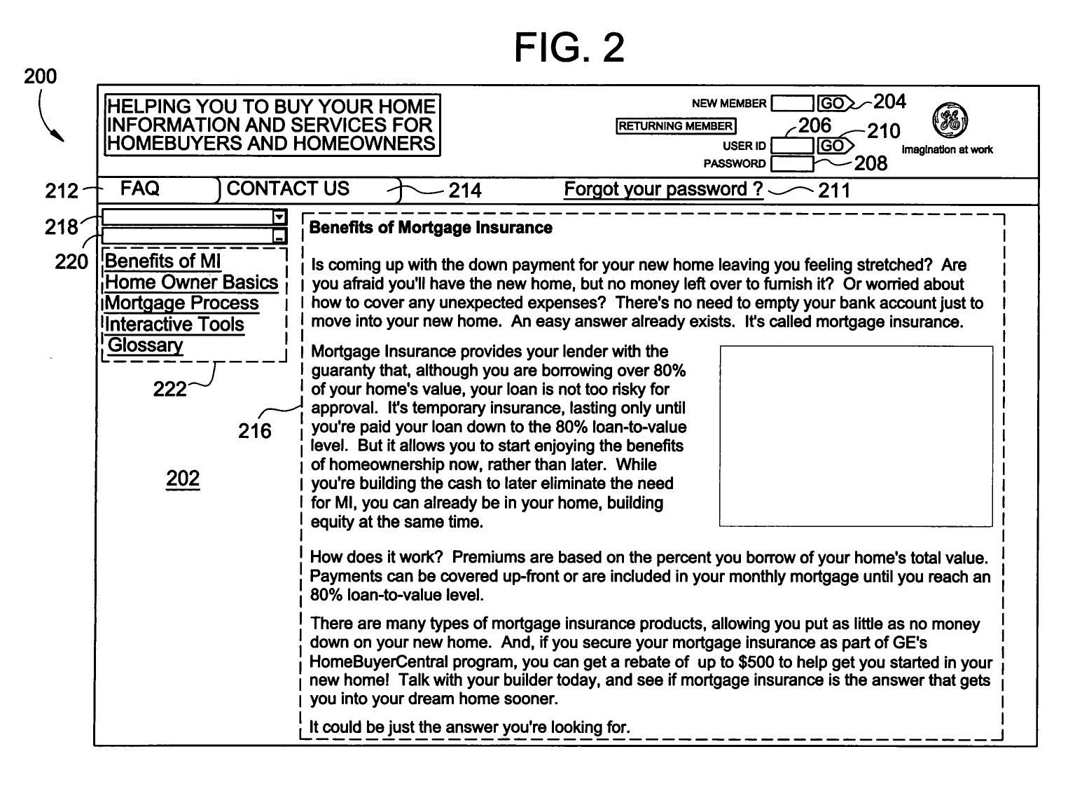

FIG. 2 illustrates a hypertext browser 200 displaying an introductory hypertext page 202. The introductory page 202 is constructed by or for a mortgage insurance provider such as the service provider 104, and includes general information about the benefits of mortgage insurance, as well as links and selection tools to allow the user to obtain more information about mortgage insurance and the purchase and financing of homes. In addition, the page 202 includes links to promotional information for the promotion of mortgage insurance provided by the service provider 104.

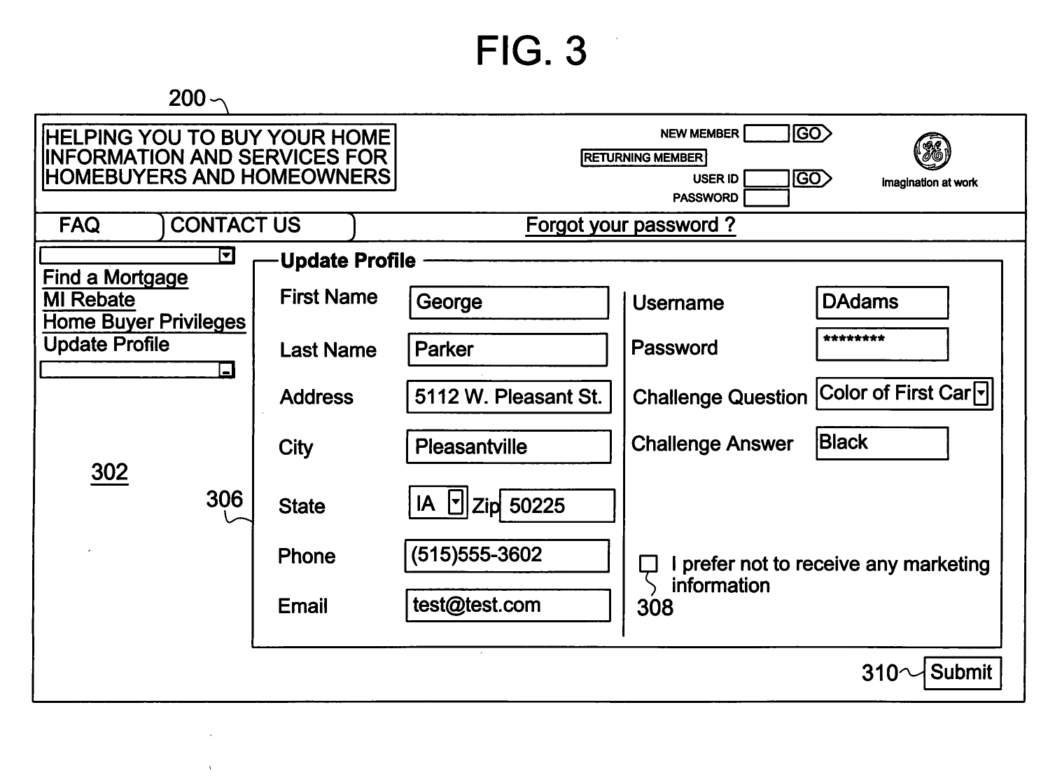

The page 202 includes a registration button 204, allowing a consumer to display a registration form, shown in FIG. 3 and discussed below, in order to provide personal information to the provider 104 and to register as a user of the system 100. The page 202 also includes username and password fields 206 and 208, respectively, as well as a “login” button 210, to allow a returning user to identify himself or herself in order to retrieve, use or allow the use of previously stored information. Once a returning user logs in, the module 113 can employ the user's stored information to tailor the display of subsequent pages to conform to the user's previously entered preferences.

In addition to the registration and login elements, the page 202 includes buttons 212 and 214, to command the display of lists of frequently asked questions and service provider contact information, respectively. The page 202 also includes explanatory material 212, providing an overview of the benefits of mortgage insurance, as well as dropdown menus 218 and 220 and a link list 222, allowing selection of additional options.

FIG. 3 illustrates the browser 200, showing a hypertext page 302. The page 302 includes a user registration form 306, including fields for the entry of user information and selection of a username and password. The form 306 also includes a checkbox 308, to allow the user to choose not to receive promotional emails and literature. Upon completion of the form 306, the user activates a “submit” button 310, to store the user information in the user information database 122. When the user activates the “submit” button, the user registration module 120 creates an entry for the database 122 and stores the entry in the database 122.

Preferably, dropdown menus similar to the menus 218 and 220 of FIG. 2 and link lists similar to the link list 222 of FIG. 2 are included in each page presented by the information and selection module 113. Selection of items from the dropdown menus 218 and 220 may suitably change the link lists presented.

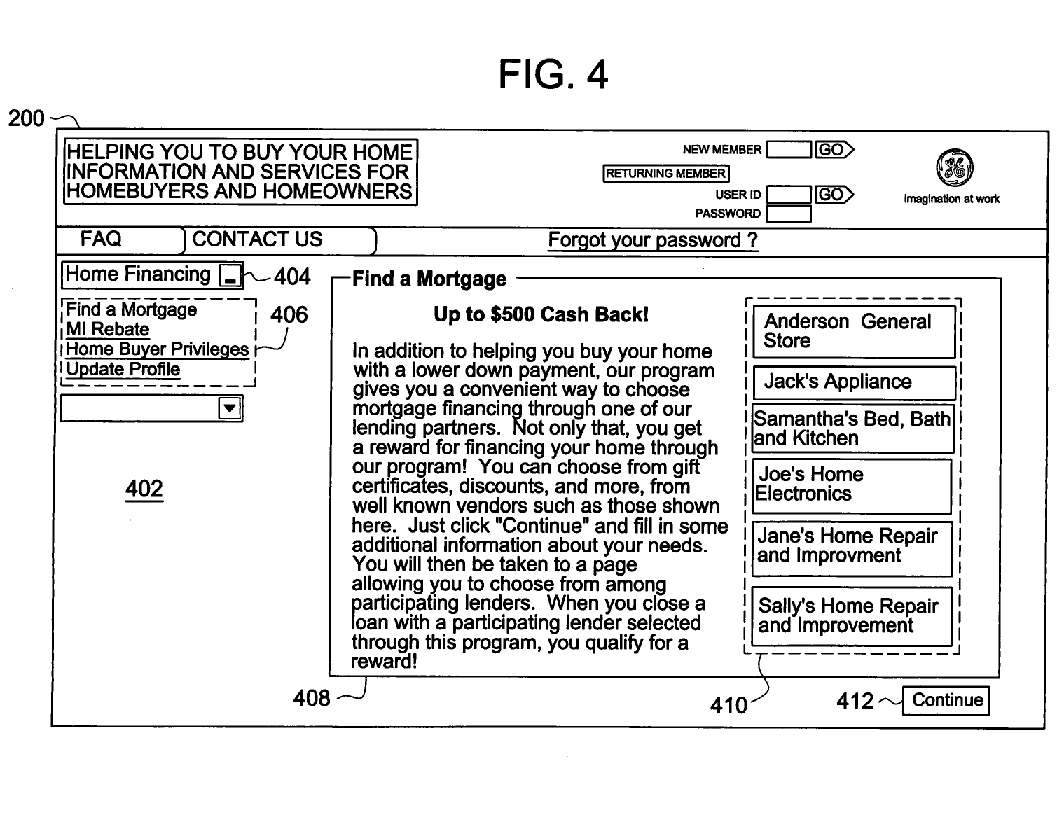

FIG. 4 illustrates the browser 200, displaying a hypertext page 402. The page 402 includes a dropdown menu 404. The menu selection “Home Financing” has been made on the dropdown menu 404, causing the presentation of “Find a Mortgage,” “MI Rebate” and “Update Profile” selections on a link list 406. The “Find a Mortgage” link has been activated, causing the display of an introductory information section 408, providing information about the use of the system 100 to select a mortgage provider, and informing the user about the incentives that are available and how to earn the incentives. The page 402 also includes a set of incentive provider logos 410, and a “continue” button 412, to be activated when the user is ready to proceed.

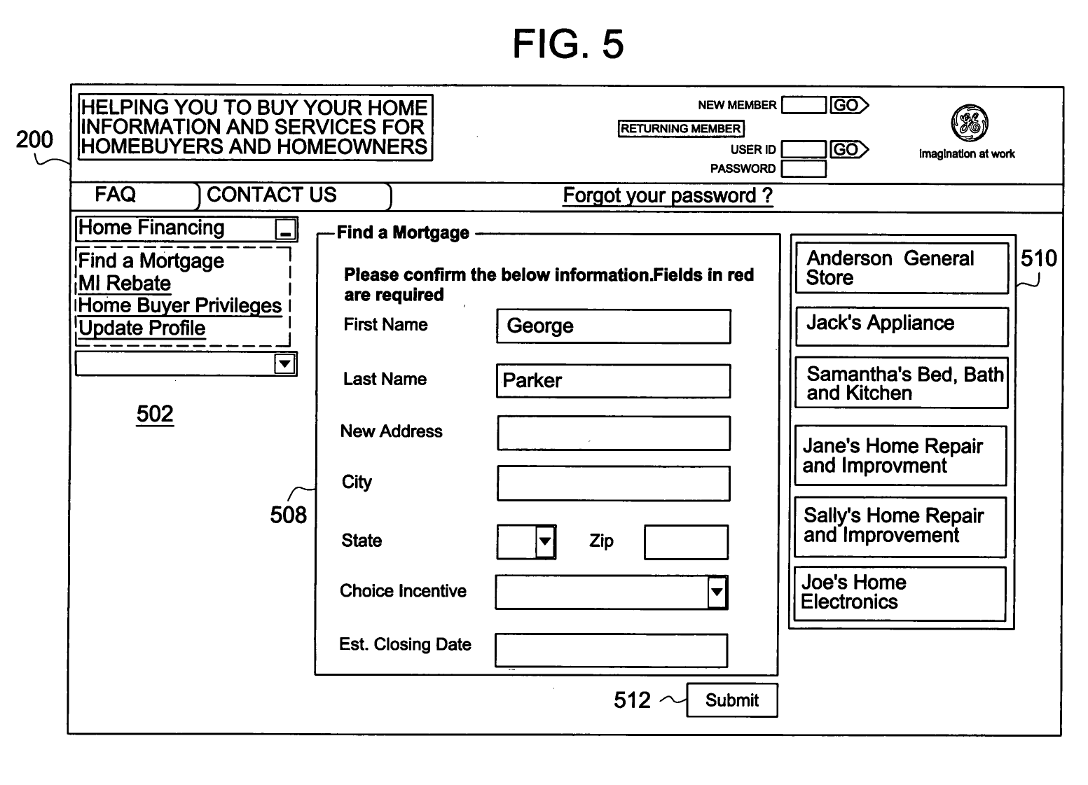

FIG. 5 illustrates the browser 200, displaying a hypertext page 502, reached after the user has activated the “continue” button on the page 402. The page 502 includes an information entry form 508 and a set of incentive provider logos 510. The information entry form 508 is already filled in with the user's name and allows the entry of information relevant to mortgage financing sought by the user, including the address of the property, the incentive desired by the user and an estimate of the closing date desired by the user. When the user makes the required entries and selections and activates the “submit” button 512, the information and selection module 113 updates the user information database 122 with the new information and searches the affiliated provider database 115, using the furnished information to select providers that may be able to meet the user's needs. For example, the address of the property is used to include or exclude mortgage providers based on whether or not they are eligible to provide mortgage financing for properties in the location specified by the user. The information and selection module 113 then retrieves information associated with the affiliated partners that have been selected and formats this information for presentation to the user, preferably in the form of a hypertext page.

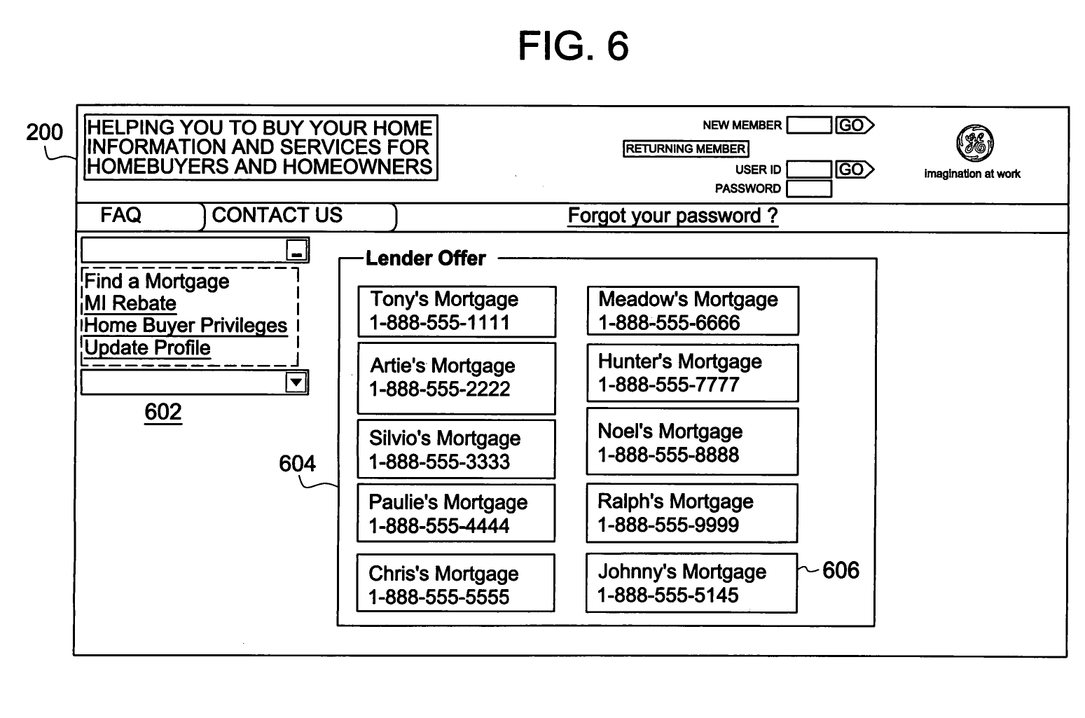

FIG. 6 illustrates the browser 200, displaying a hypertext page 602. The page 602 is constructed and presented by the information and selection module 113, after the user has provided information using the form 508 and the information and selection module 113 has used the information to select mortgage providers for presentation to the user. The page 602 includes a provider display 604, showing a logo for each of the selected providers. Preferably, the logos are implemented in the form of hypertext links, so that activation of a link presents a subsequent page providing more information about the selected provider. The links may be designed to direct the browser 200 to pages maintained by the provider itself, for example, pages hosted on the computer 108A. Alternatively, the links may direct the browser 200 to pages maintained for the selected provider on the server 102 or a similar server maintained by or for the service provider 104.

If the user applies for mortgage financing with the affiliated partner to which the user was directed, a suitable indication may be stored in the user information database 122, to indicate the user's qualification for incentives and also for use in evaluating the effectiveness of the system 100 and the various marketing tools provided by the system 100. For example, the user may be provided with an authenticator, such as a verification code or transaction code, by the affiliated provider. The user may enter the authenticator in order to establish his or her eligibility for incentives.

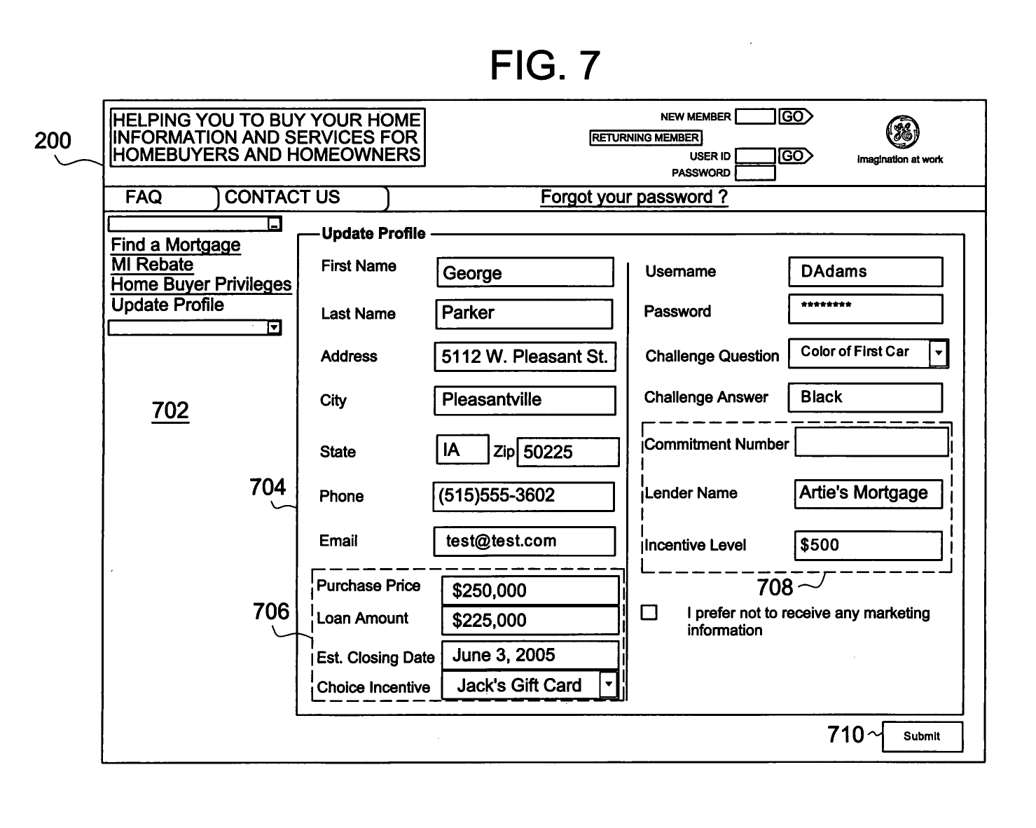

Once the user has applied for a service from an affiliated provider or otherwise established a relationship with an affiliated provider, the user may use the system 100 to store information relating to the service or relationship. This information then becomes available to the user when the user employs the system 100 to review his or her stored personal information. FIG. 7 illustrates the browser 200, displaying a hypertext page 702, reached after the user has chosen to review his or her personal information after storing information related to a relationship with an affiliated provider. The page 702 includes an information form 704, including information that has been previously stored. The user may add or change information as desired. In the present case, the user has selected a mortgage financing company and provided the company with relevant information, and this information has been stored in the database 122. The information furnished to the affiliated service provider is displayed in the form 704, providing a convenient way for the user to review it. If the user wishes to change information on the form 704, any information which is relevant to his or her transaction with the affiliated provider and which is not inhibited from being changed may be transmitted to the affiliated provider.

Once the user has completed a qualifying transaction, he or she is provided with evidence of eligibility for an incentive, and may then invoke the information and selection module 113 to provide the evidence of eligibility and claim the incentive. In the present case, the evidence of eligibility is a mortgage insurance commitment number for a mortgage insurance commitment policy underwritten by the service provider 104.

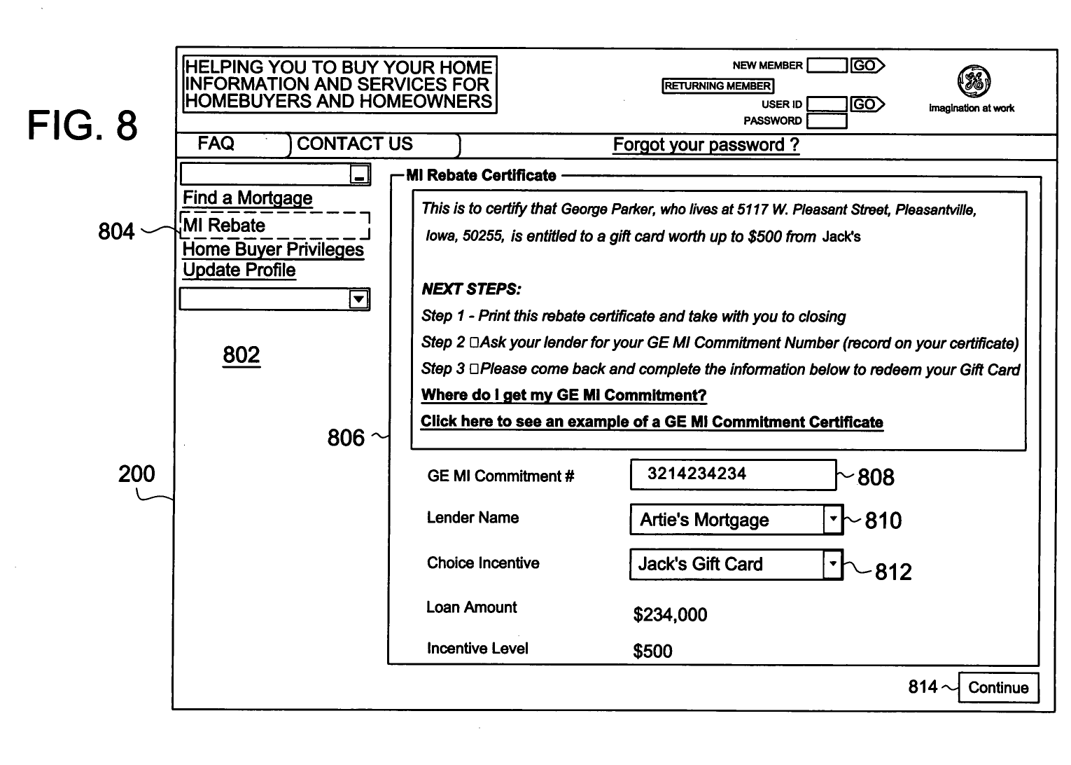

FIG. 8 illustrates the browser 200 displaying a hypertext page 802, with elements displayed upon activation of the “MI Rebate” link 804. The page 802 includes an instruction and information entry section 806, including instructions for claiming the incentive. The instruction and information entry section 806 includes an information entry field 808 and drop down menus 810 and 812. The user enters a code that has been provided by the affiliated provider in the field 808, and makes selections from the menus 810 and 812 to indicate the identity of the provider and the desired incentive, respectively. In the present case, the user has already furnished this information, so it appears upon the initial display of the page 802, along with the amount of the insured mortgage and the value of the incentive. If desired, the user may select a different incentive using the menu 212. Once the information has been entered and the user is satisfied, the user activates the “continue” button and the incentive is ordered. The fact that the incentive has been qualified for and ordered, and identification of the specific incentive ordered, are stored in the database 122.

In addition to assisting with the selection of a service provider and providing communication and information storage and retrieval services to make the transaction more convenient, the system 100 suitably stores and presents educational information of interest to users and potential users.

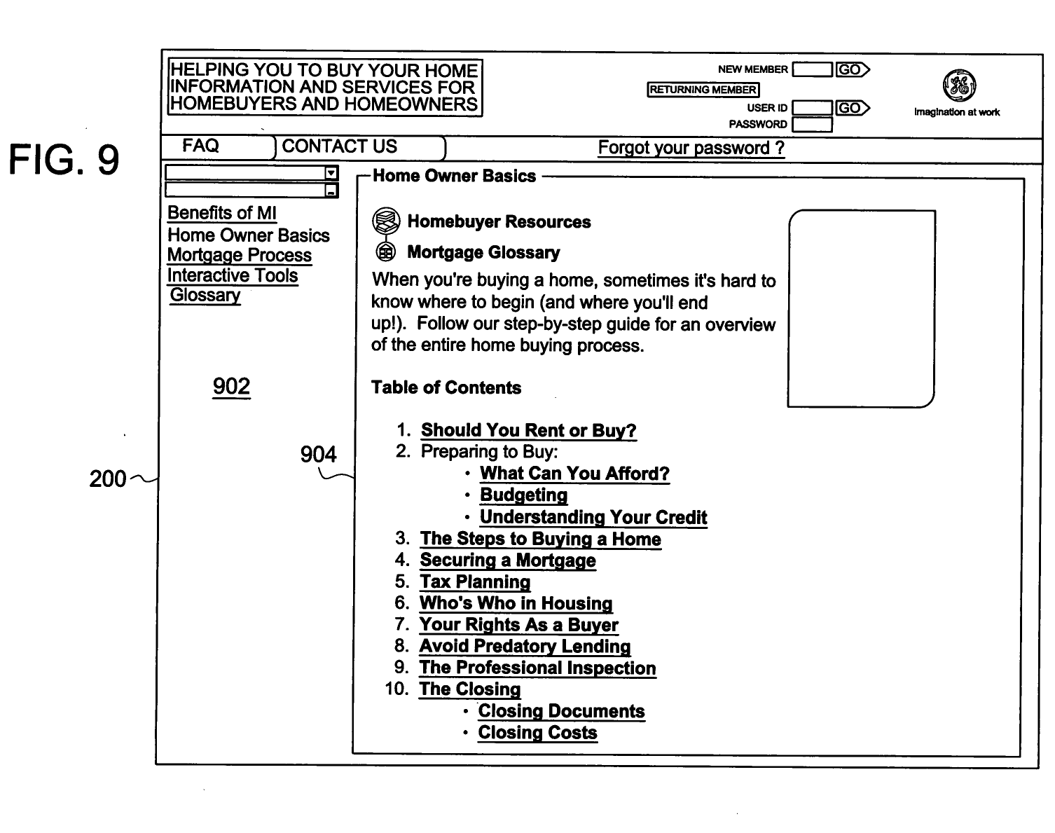

FIGS. 9, 10, 11 and 12 illustrate hypertext pages providing exemplary educational information to a user, reached by activating one of the links in the hypertext link list 222 of FIG. 2, or similar links appearing on different pages. FIG. 9 illustrates the browser 200 displaying an educational information page 902, reached upon activating the “Home Owner Basics” link in the list 222 of FIG. 2. The list 222 of FIG. 2 is displayed when the selection “Hume Buyer Resources” is made using the dropdown menu 220.

The page 902 includes an information section 904, organized as a list of hyperlinks to additional information about home purchasing and financing. By activating one of these links, the user can display further information. Suitably, the links activate new windows for display of the information, so that a user may simply close the new window after reading the information.

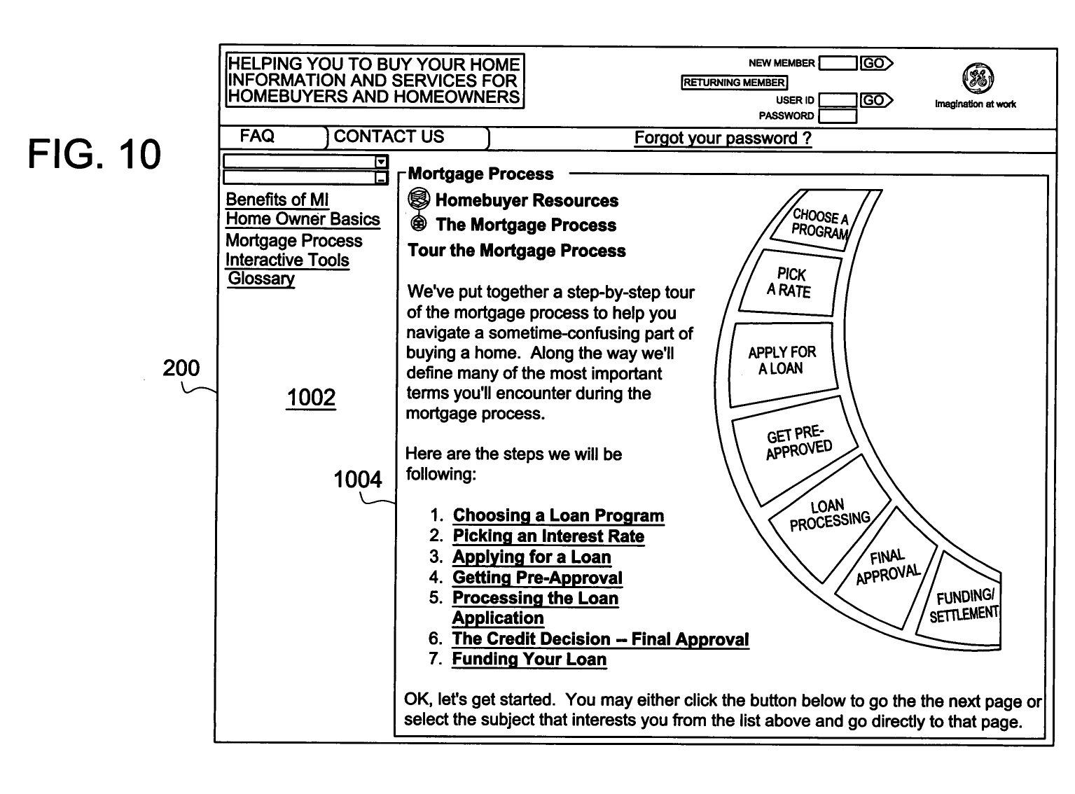

FIG. 10 illustrates the browser 200 displaying a page 1002, reached upon activating a “Mortgage Process” link in the list 222. The page 1002 includes an information section 1004, including explanatory material and links to information about the steps of the mortgage process.

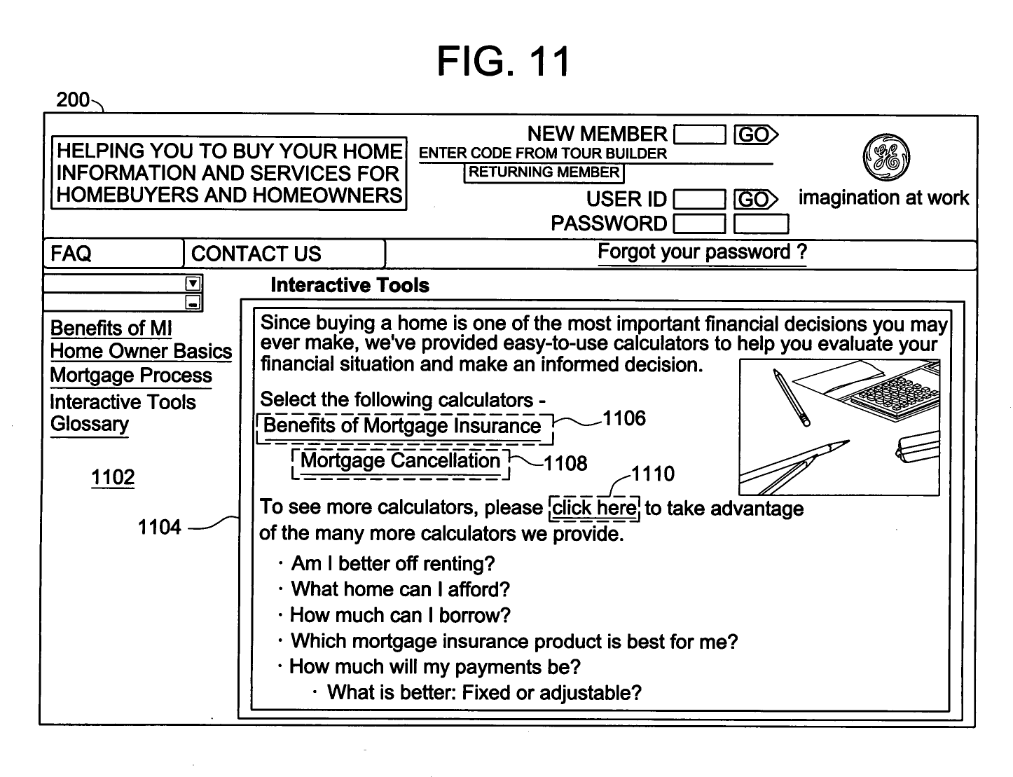

FIG. 11 illustrates the browser 200 displaying a page 1102, reached upon activating the “Interactive Tools” link in the list 222. The page 1102 includes an information section 1004, including explanatory material and links 1106 and 1108 to selected online calculators, as well as a link 1110 to an additional selection of online calculators.

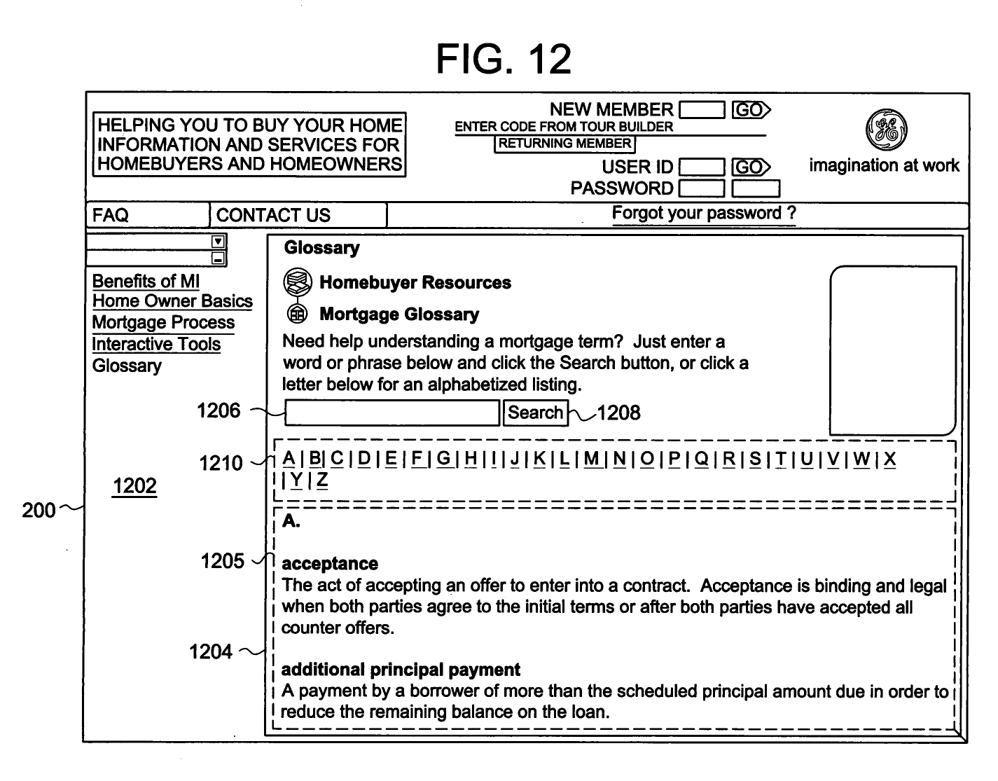

FIG. 12 illustrates the browser 200 displaying a page 1202, reached upon activating the “Glossary” link in the list 222. The page 1202 includes an information section 1204. The information section 1204 includes initial glossary entries 1205, and tools for navigating through these entries and additional entries. The tools include a search field 1206 and search button 1208 and an alphabetical list 1210, comprising a hypertext link for each letter of the alphabet. Activating any of the links in the list 1210 suitably opens a window showing all the entries beginning with that letter. The user can scroll up and down within the window to find a desired entry.

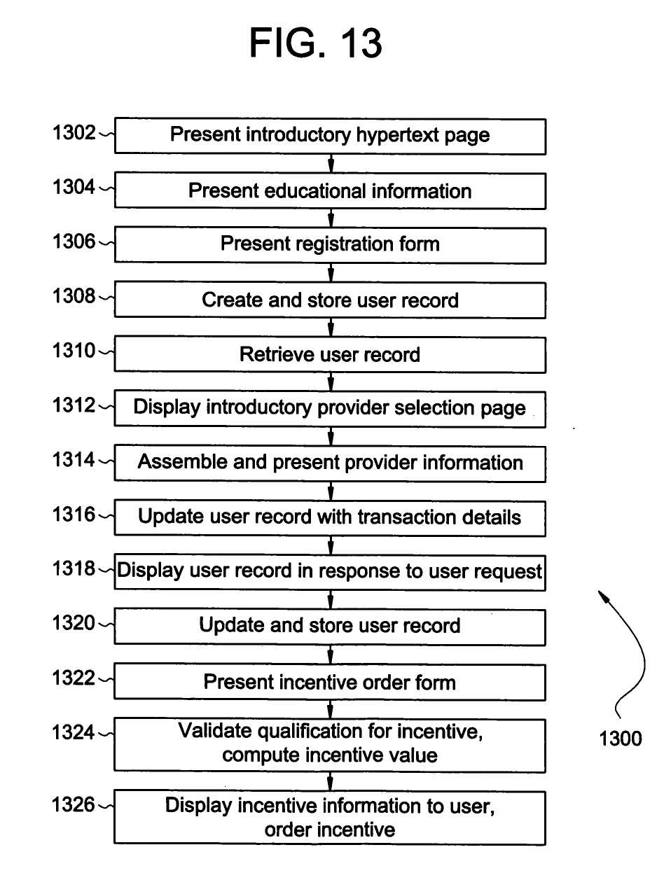

FIG. 13 illustrates the steps of a process 1300 of promoting financial services according to an aspect of the present invention. At step 1302, upon sensing that a user's browser has been directed to a hypertext page providing introduction and access to educational and financial services selection, an introductory hypertext page is transmitted for display on a user computer, preferably through a publicly accessible network such as the Internet. The hypertext page is preferably hosted on a server similar to the sever 102 of FIG. 1, accessible to user computers as well as computers operated by or for affiliated service providers. At step 1304, in response to user selections, educational information is presented to the user, suitably in the form of hypertext pages. Suitably, the user may search for or browse through educational material by activating hyperlinks and entering search terms, and each page includes elements providing convenient ways to find and display additional pages. As an example, a page may present a list of home repair projects, including deck repair, roof repair, siding repair, termite proofing and lawn renovation. Each entry in the list is suitably presented in the form of a hyperlink. If the user selects the hyperlink for, to take an example, siding repair, an introductory page is presented giving an overview of the importance of regular siding maintenance and presenting a series of questions used to determine the scale and general nature of a contemplated project. When the user has answered these questions, succeeding pages are presented, either soliciting more information or, if sufficient information has been provided, providing a set of instructions and resources for the project to be undertaken.

At step 1306, in response to a selection by the user, a registration form is presented to the user, allowing the user to enter personal information and to indicate preferences and interests. Preferences may suitably include preferred display formats and categories of information in which the user is interested, and interests may suitably include financial transactions contemplated by the user and services needed to assist with those transactions. At step 1308, upon user entry of personal information and designation of preferences and interests, a user record is created and stored, suitably in a database such as the user information database 122 of FIG. 1.

The process 1300 is preferably designed so that a registered user can log in at any time after initial registration. When the user logs in, previously entered information, as well as saved information about the user's activities and choices, will be available. At step 1310, after the user's pausing of activities and subsequent login, the user record for the user is retrieved, allowing the user to make further choices as desired. At step 1312, upon the user's selection to choose a financial service provider such as a mortgage lender, an introductory provider selection page is displayed, including general information about the selection process, as well as information about incentives available to the user and a form for entering information to be used in searching for appropriate providers and for making an initial choice of incentive. At step 1314, upon submission by the user of the requested information, appropriate choices are made among affiliated providers and provider information is assembled into a hypertext page and displayed for the user. Preferably, the page includes a link to each provider. When the user activates a link to a provider, the user's browser is directed to a hypertext page with information about the provider and an opportunity to enter into a transaction with the provider.

At step 1316, upon a user's entry into a transaction with the provider, and upon submission of an indication by the user that he or she has entered into the transaction and the details of the transaction, the user record is updated with details of the transaction. At step 1318, upon a request by the user, the user record is displayed, including the transaction details. At step 1320, upon user revisions to the stored information, the user record is updated and stored.

At step 1322, upon a user selection to order an incentive, the user record is retrieved and an incentive order form is displayed. The incentive order form includes user identification information. In addition, if the user has already qualified for the incentive and the qualification information has been stored in the user record as part of the transaction with an affiliated provider, the form includes the qualification information. The form also includes identification of any previously made choice of incentive, as well as the value of the incentive if this can be computed from the stored information. If the qualification information is not stored, the user may provide the information by entering it into an appropriate field. The form also allows the user to change his or her choice of incentive. At step 1324, upon a user's submission of the incentive order form, the qualification information is validated. If the information is invalid, the user is invited to resubmit the information. Otherwise, information associated with the validation information is retrieved and examined. For example, the validation information may be a mortgage insurance certificate number associated with a mortgage. In this case, the value of the mortgage is known to the issuer of the certificate. If the issuer of the certificate is responsible for providing the incentive and the level of the incentive is based on the value of the mortgage, the issuer can examine the value of the mortgage and compute the level of the incentive earned. At step 1326, a display is presented informing the user of the type and value of the incentive and the incentive is ordered.

While the present invention is disclosed in the context of aspects of an embodiment employing a specific system and exemplary web pages, it will be recognized that a wide variety of implementations may be employed by persons of ordinary skill in the art consistent with the above discussion and the claims which follow below.

1. A financial information and services selection system for coordinating consumer selection of financial services, comprising:
a database of provider information including identification of affiliated providers, the services offered by the providers and categories of customers served by the providers and incentives offered by the providers;
an incentive information database including identification of incentives offered in exchange for selecting affiliated providers, levels of incentives offered and qualification requirements for each incentive and incentive level;
a user registration module allowing registration of a consumer in order to allow selection of providers, the user registration module receiving user information and preferences for use in choosing affiliated providers to be presented for selection by a user;
a selection module for coordinating selection by a consumer of affiliated providers and managing qualification for and delivery of incentives offered for selecting affiliated providers.

2. The system of claim 1, further including a user information database for storing user information collected by the registration module.

3. The system of claim 2, wherein the selection module selects affiliated providers to be offered to the user, the selection of providers being based on user information and user preference information stored in the user information database.

4. The system of claim 3, wherein the selection module collects information identifying affiliated service providers and presents this information to the user in the form of one or more hypertext pages including hypertext links directing the user to resources providing further information and allowing the user to conduct transactions.

5. The system of claim 4, wherein the selection module receives and stores information indicating that the user has entered into a transaction with an affiliated provider.

6. The system of claim 5, wherein the information indicating that the user has entered into a transaction with an affiliated provider includes an indication that the user has qualified for an incentive.

7. The system of claim 6, further comprising an information database including educational information about financial transactions of potential interest to consumers, and wherein the selection module is operative to examine user information to identify educational information of likely interest to the user and organize the information for presentation to the user upon user requests.

8. The system of claim 7, wherein one or more of the affiliated providers is a mortgage lender and wherein the system allows selection of a provider of mortgage financing, with the mortgage financing being accompanied by a mortgage insurance policy underwritten by a designated provider.

9. A method of promotion of financial services to consumers, comprising the steps of:
collecting and storing registration information from a user in order to identify likely user needs and preferences;
identifying potential service providers for financial services likely to be required by the user;
presenting information and tools for allowing user selection of a desired provider, as well as information about incentives offered for selecting from a set of designated providers;
upon user selection of a desired provider and entry into a transaction with the provider, receiving qualification information indicating the user's eligibility for an incentive; and
validating the qualification information and allowing the user to select and claim the desired incentive.

10. The method of claim 9, further comprising a step of assembling and storing educational information of interest to consumers.

11. The method of claim 10, further comprising a step of selecting educational information and presenting it to a user based on user preferences and requests.

12. The method of claim 11, wherein the step of presenting information and tools for allowing user selection of a desired provider comprises assembling the information and tools in the form of one or more hypertext pages and presenting the pages for display using a hypertext browser residing on a user operated computer.

13. The method of claim 12, wherein one or more of the hypertext pages includes a set of hypertext links to provider information, each of the links to provider information pointing to information and tools for conducting a transaction with a specified provider.

14. The method of claim 13, wherein the step of receiving qualification information includes receiving an authenticating code furnished by a provider with which the user conducts the transaction and updating the stored registration information with the qualification information.

15. The method of claim 14, wherein the transaction is the securing of mortgage financing with a selected provider, the mortgage financing being accompanied by mortgage insurance underwritten by a designated provider.
